(19) United States
(12) Patent Application Publication
(10) Pub. No.: US 2025/0209814 A1
(43) Pub. Date: Jun. 26, 2025

(54) OBJECT-ORIENTED METHOD FOR IDENTIFYING AND CLASSIFYING SURFACE LITHOLOGY IN HYPERSPECTRAL REMOTE SENSING IMAGE

(71) Applicant: CHENGDU UNIVERSITY OF TECHNOLOGY, Chengdu City (CN)

(72) Inventors: Hanhu LIU, Chengdu City (CN); Heng ZHANG, Chengdu City (CN); Ronghao YANG, Chengdu City (CN)

(73) Assignee: CHENGDU UNIVERSITY OF TECHNOLOGY, Chengdu City (CN)

(21) Appl. No.: 18/634,210

(22) Filed: Apr. 12, 2024

(30) Foreign Application Priority Data
Dec. 26, 2023 (CN) 202311811056.0

(51) Int. Cl. G06V 20/10; G06V 10/24; G06V 10/58; G06V 10/764; G06V 10/77; G06V 10/774; G06V 10/776; G06V 10/80; G06V 10/82; G06V 20/13; G06V 20/70

(52) U.S. Cl. CPC G06V 20/194; G06V 10/24; G06V 10/58; G06V 10/764; G06V 10/7715; G06V 10/774; G06V 10/776; G06V 10/806; G06V 10/82; G06V 20/70; G06V 20/13

(57) ABSTRACT

The present disclosure provides an object-oriented method for identifying and classifying surface lithology in a hyperspectral remote sensing image. The method includes: determining a hyperspectral remote sensing image in a research area and a lithology type label corresponding to each hyperspectral remote sensing image, and preparing a hyperspectral remote sensing dataset; dividing pixels of the hyperspectral remote sensing image in the hyperspectral remote sensing dataset into a training set and a test set through a division strategy for a dataset without leakage information; and based on a deep learning method, extracting and fusing, through a double-branch multi-scale dual-attention mechanism network based on the training set and the test set, a spectral feature and a spatial feature of a hyperspectral remote sensing image to be tested, to generate a fused feature for representing a surface lithology type of the hyperspectral remote sensing image to be tested.

### CROSS REFERENCE TO RELATED APPLICATION

This application claims foreign priority benefits under 35 U.S.C. § 119 (a)-(d) to Chinese Patent Application No. 202311811056.0 filed on Dec. 26, 2023, the disclosure of which is hereby incorporated herein by reference in its entirety.

### TECHNICAL FIELD

The present disclosure relates to the field of hyperspectral remote sensing image processing, and in particular to an object-oriented method for identifying and classifying surface lithology in a hyperspectral remote sensing image.

### BACKGROUND

Surface lithology identification is a fundamental research direction in the field of geology. However, the surface lithology identification is still at a stage of manual on-site exploration and inspection at present, which causes high time and material costs. A hyperspectral remote sensing technology promotes the development of other fields, and shows great potential in the field of geological lithology identification.

At present, an earliest method for lithology identification is a spectral angle mapper (SAM) method. Because of a large amount of manual operations and low accuracy, the SAM algorithm shows disadvantages with the development of computer computing. Manual operations are greatly reduced through machine learning. Therefore, efficiency is improved. Common machine learning includes a principal component analysis (PCA) algorithm, a minimum noise fraction (MNF) algorithm, and an independent component analysis (ICA) algorithm, and a greedy algorithm. However, with the increasing amount of data that can be obtained in modern times, deep learning has begun to replace machine learning and has been widely used in other fields, while slowly developing in the field of hyperspectral remote sensing recognition. Simple convolutional networks are mostly used during deep learning. Therefore, it is difficult to extract a complex high-dimensional spectral feature and spatial feature from hyperspectral data, thus identification accuracy of each category of features is low under conditions that no information leaks and there is a small quantity of samples.

### SUMMARY

An objective of the present disclosure is to provide an object-oriented method for identifying and classifying surface lithology in a hyperspectral remote sensing image, to resolve a problem that identification accuracy of each category of features is low under conditions that no information leaks and there is a small quantity of samples.

To achieve the above objective, the present disclosure provides the following technical solutions.

An object-oriented method for identifying and classifying surface lithology in a hyperspectral remote sensing image includes:
determining a hyperspectral remote sensing image in a research area and a lithology type label corresponding to each hyperspectral remote sensing image, and preparing a hyperspectral remote sensing dataset;
dividing pixels of the hyperspectral remote sensing image in the hyperspectral remote sensing dataset into a training set and a test set through a division strategy for a dataset without leakage information, where the division strategy for a dataset without leakage information ensures that there is no overlap between training data in the training set and test data in the test set; and
based on a deep learning method, extracting and fusing, through a double-branch multi-scale dual-attention mechanism network, a spectral feature and a spatial feature of a hyperspectral remote sensing image to be tested, to generate a fused feature, where the double-branch multi-scale dual-attention mechanism network is constructed and trained through the training set and the test set; the double-branch multi-scale dual-attention mechanism network includes a spectral branch, a spatial branch, and a classification head; the spectral branch includes a multi-scale spectral residual attention (MSeRA) densely connected module and a spectral attention mechanism module, and the spectral branch is used to extract a diagnostic spectral feature in the spectral feature; the spatial branch includes a spatial densely connected module and a spatial attention mechanism module, and the spatial branch is used to extract a diagnostic spatial feature in the spatial feature; the classification head is used to fuse the diagnostic spectral feature extracted by the spectral branch and the diagnostic spatial feature extracted by the spatial branch, to generate the fused feature; and the fused feature is used to represent a surface lithology type of the hyperspectral remote sensing image to be tested.

According to the specific embodiments provided by the present disclosure, the present disclosure provides the following technical effect. In comparison to the technical solution of performing identification and classification through a simple convolutional network, in embodiments of the present disclosure, because the double-branch multi-scale dual-attention mechanism network is constructed with the training set and the test set through the division strategy for a dataset without leakage information, there is no overlap between the training data in the training set and the test data in the test set. Therefore, accuracy of recognition and classification of the double-branch multi-scale dual-attention mechanism network is greatly improved, and identification accuracy of each category of features can be improved under conditions that no information leaks and there is a small quantity of samples.

### BRIEF DESCRIPTION OF THE DRAWINGS

To describe the technical solutions in embodiments of the present disclosure or in the prior art more clearly, the accompanying drawings required in embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is a flowchart of an object-oriented method for identifying and classifying surface lithology in a hyperspectral remote sensing image according to an embodiment 1 of the present disclosure;

FIG. 2 is a diagram of a structure of a double-branch multi-scale dual-attention mechanism network according to an embodiment 1 of the present disclosure;

FIG. 3 is a diagram of a structure of a multi-scale spectral residual attention module according to an embodiment 1 of the present disclosure; and

FIG. 4 is a flowchart of an object-oriented method for identifying and classifying surface lithology in a hyperspectral remote sensing image according to an embodiment 2 of the present disclosure.

### DETAILED DESCRIPTION

The technical solutions of embodiments of the present disclosure are clearly and completely described below with reference to the drawings in embodiments of the present disclosure. Apparently, the described embodiments are merely a part rather than all of embodiments of the present disclosure. All other embodiments obtained by those skilled in the art based on embodiments of the present disclosure without creative efforts shall fall within the protection scope of the present disclosure.

An objective of the present disclosure is to provide an object-oriented method for identifying and classifying surface lithology in a hyperspectral remote sensing image, to improve identification accuracy of each category of features under conditions that no information leaks and there is a small quantity of samples.

In order to make the above objective, features and advantages of the present disclosure clearer and more comprehensible, the present disclosure will be further described in detail below in combination with accompanying drawings and particular implementation modes.

### Embodiment 1

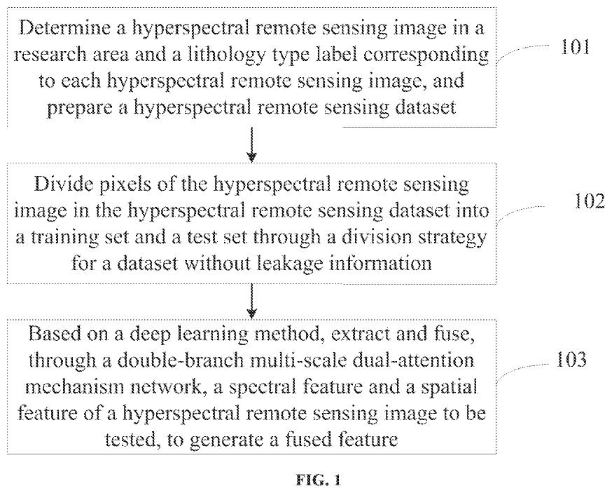

As shown in FIG. 1, an object-oriented method for identifying and classifying surface lithology in a hyperspectral remote sensing image includes the following steps.

Step 101: Determine a hyperspectral remote sensing image in a research area and a lithology type label corresponding to each hyperspectral remote sensing image, and prepare a hyperspectral remote sensing dataset.

Step 102: Divide pixels of the hyperspectral remote sensing image in the hyperspectral remote sensing dataset into a training set and a test set through a division strategy for a dataset without leakage information. The division strategy for a dataset without leakage information ensures that there is no overlap between training data in the training set and test data in the test set.

Step 103: Based on a deep learning method, extract and fuse, through a double-branch multi-scale dual-attention mechanism network, a spectral feature and a spatial feature of a hyperspectral remote sensing image to be tested, to generate a fused feature. The double-branch multi-scale dual-attention mechanism network is constructed and trained through the training set and the test set. The double-branch multi-scale dual-attention mechanism network includes a spectral branch, a spatial branch, and a classification head. The spectral branch includes a multi-scale spectral residual attention (MSeRA) densely connected module and a spectral attention mechanism module, and the spectral branch is used to extract a diagnostic spectral feature in the spectral feature. The spatial branch includes a spatial densely connected module and a spatial attention mechanism module, and the spatial branch is used to extract a diagnostic spatial feature in the spatial feature. The classification head is used to fuse the diagnostic spectral feature extracted by the spectral branch and the diagnostic spatial feature extracted by the spatial branch, to generate the fused feature. The fused feature is used to represent a surface lithology type of the hyperspectral remote sensing image to be tested. The diagnostic spectral feature is a spectral feature that is important for final classification.

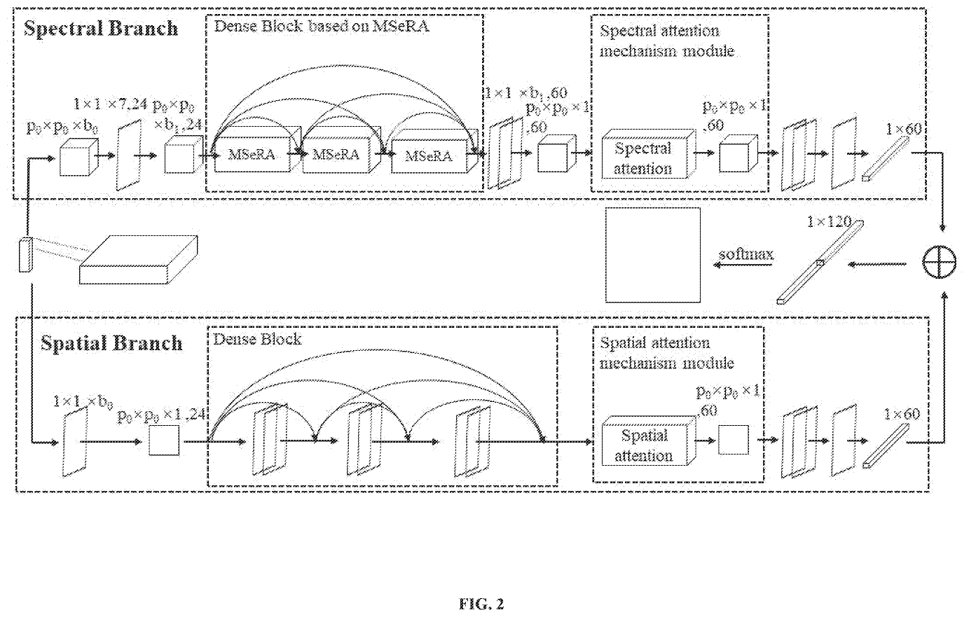

As shown in FIG. 2, the double-branch multi-scale dual-attention (DBMSDA) network includes three parts, namely, a spectral branch, a spatial branch, and a classification head. In FIG. 2, a spectral branch at a top is the spectral branch, a spectral branch at a bottom is the spatial branch. Features of the spectral branch and the spatial branch are finally fused for classification. The spectral branch includes a MSeRA densely connected module and a spectral attention module. The spatial branch includes a spatial densely connected module and a spatial attention module, where po represents a height and width of a divided hyperspectral data patch, and the height and width are generally set to be equal. b₀ represents the spectral dimension of the divided hyperspectral data patch, b₁ represents a spectral dimension obtained after 3D convolution is performed once, and softmax represents a normalized exponential function.

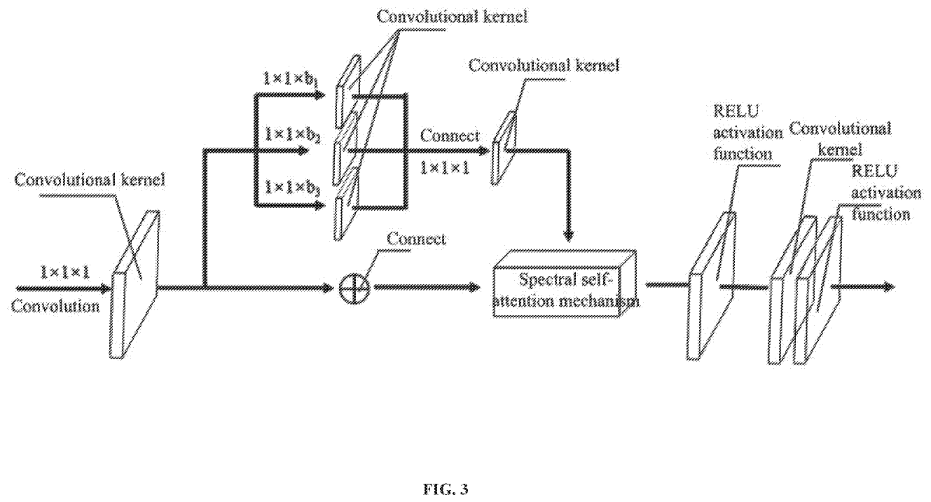

As a basic convolution structure of the DBMSDA network, a 3D convolutional neural network (3D-CNN) is used to extract spatial information and spectral information of a hyperspectral image (HSI). A densely connected network exists in the spectral branch and the spatial branch. The spectral branch takes a MSeRA module as a connection unit of the densely connected network. As shown in FIG. 3, the MSeRA module includes a MSeRA densely connected module and a spectral self-attention module. Data explosion and vanishing gradient can be avoided. In addition, spectral features in hyperspectral data can be extracted fully, so that the spectral features are more fine and diagnostic. Conv represents a convolutional layer, ReLU represents an activation function, CAM represents class activation mapping, Concatenate represents a connection function, and b1′, b2, and b3 represent sizes of convolutional kernels at different scales in a multi-scale extraction module, respectively setting to b1-3, b2=5, and b3=7.

The spatial branch includes a simple 3D-CNN, to avoid distorting information in the learned spectral feature due to excessive spatial information. Because the hyperspectral image is classified based on the spectral information, the spatial information plays only an auxiliary role. Therefore, difficulty in extraction of the spectral information that is caused by excessive spatial information needs to be avoided.

A spectral-dimensional multi-scale extraction module is used in the MSeRA module, to extract spectral information in the hyperspectral data. The DBMSDA network may capture, by a multi-scale spectral dense block, a spectral feature at a different level corresponding to a plurality of receptive fields in each channel, to obtain richer spectral information, and improve classification performance.

There are two self-attention mechanisms in the spectral branch and the spatial branch, respectively called a spectral self-attention mechanism and a spatial self-attention mechanism. The two self-attention mechanisms emphasize useful feature information and discard useless feature information. In addition, the self-attention mechanisms further extract global contextual information.

According to the present disclosure, the spectral information and the spatial information of the hyperspectral data are first extracted through the 3D-CNN, the diagnostic spectral feature is extracted through the densely connected network and the spectral self-attention mechanism in the spectral branch, and the diagnostic spatial feature is extracted through the densely connected network and the spatial self-attention mechanism in the spatial branch. Finally, the diagnostic spectral feature and the diagnostic spatial feature are fused for classification.

During actual application, according to the present disclosure, the 3D-CNN is used as the convolution structure of the DBMSDA network for extracting hyperspectral information features. To avoid data explosion and vanishing gradient, results are normalized by performing batch normalization (BN) on samples+operating an activation function Mish after each convolution during a dense connection. Then cubic feature maps obtained by the spectral branch and the spatial branch are converted into one-dimensional vector features by a random dropout (Dropout) layer and a global average pooling layer. Finally, the two one-dimensional vector features are connected to form a whole, and classified by a linear layer.

Step 104: Identify and classify the surface lithology of the hyperspectral remote sensing image based on the fused feature.

According to the present disclosure, average accuracy OA of a final classification result is increased from 83.83% to 85.2%, which is increased by 1.37%, overall accuracy AA of the final classification result is increased from 78.89% to 84.09%, which is increased by 5.2%, and a Kappa coefficient is increased from 0.7286 to 0.7523.

### Embodiment 2

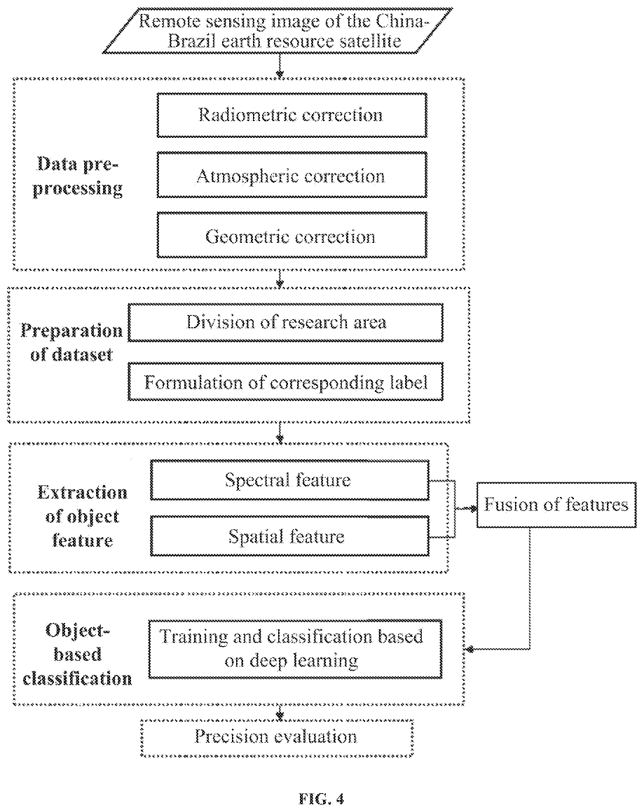

A hyperspectral remote sensing image of the China-Brazil earth resource satellite No. 1 satellite is used as an example. As shown in FIG. 4, an object-oriented method for identifying and classifying surface lithology in a hyperspectral remote sensing image provided in the present disclosure includes the following steps.

S1: Obtain a hyperspectral remote sensing image of the China-Brazil earth resource satellite No. 1 satellite in a free band, and perform pre-processing on the hyperspectral remote sensing image of the China-Brazil earth resource satellite No. 1 satellite, where the pre-processing includes a radiometric correction, an atmospheric correction, and a geometric correction.

S2: Based on the hyperspectral remote sensing image of the China-Brazil earth resource satellite No. 1 satellite, divide a research area, and formulate a corresponding label, obtain a hyperspectral remote sensing image in the research area and a label corresponding to the hyperspectral remote sensing image in the research area, and prepare a hyperspectral remote sensing dataset.

S3: Based on the hyperspectral remote sensing image in the research area, divide pixels of the hyperspectral remote sensing image into a training set and a test set through a division strategy for a dataset without leakage information.

S4: Based on the training set and the test set, separately extract and fuse a spectral feature and a spatial feature through a double-branch multi-scale dual-attention mechanism network, and train and classify the spectral feature and the spatial feature for identifying and classifying surface lithology.

Division of the research area and formulation of the label in S2 specifically includes:

S2.1: Division of the research area is to select, from the research area, an area in which good bedrock outcrop is not covered by vegetation.

S2.2: Formulation of the label is to automatically perform, based on stratigraphic boundary data, label classification on pixels representing each category of different lithology.

The research area is located in Kangyu Township, Bomi County, Linzhi City, Tibet Autonomous Region, in which bedrock outcrop is not covered by vegetation.

Previously, when a related label is formulated, each corresponding label is manually drawn. As an improvement in the present disclosure, a label of each category of different lithology is divided based on the stratigraphic boundary data through ENVI software and ArcGis software, to obtain a lithology label map of the research area.

A size of the research area is 300×300 pixels, to ensure that bedrock in the research area is outcropped and that more lithological categories are included. In this embodiment, there are six lithological categories.

For a hyperspectral remote sensing image with a size of 300×300×166 obtained in step S2, two FIG. 300 respectively represent a height and width of the image in a unit of pixel, and 166 represents a quantity of bands. For a lithology label map with a size of 300×300, two FIG. 300 respectively represent a height and width in a unit of pixel. There are six lithological categories, including metamorphic rocks such as schist and kyanite, sedimentary rocks such as siltstone slate, mudstone sandstone, and sandstone, fine-grained detrital quartz sandstone, slate, and quaternary sediments.

Further, S3 includes the following steps.

S3.1: Divide a training set and a test set for the hyperspectral remote sensing image with a size of 300×300×166 based on a characteristic of the hyperspectral data. The characteristic of the hyperspectral data is that image information and spectral information are rich. The hyperspectral data may be referred to as a cube. Each image element is a small cube of the cube. A plane of the cube includes spatial information, and continuous spectral information in a depth direction.

S3.2: Ensure that there is no information leakage between the training set and the test set.

At present, there is a potential information leakage between a patch (patch)-based classification method used in most network models and a data division strategy corresponding to the patch (patch)-based classification method. Because an objective of the patch-based classification method is to predict a label of a center pixel, a division strategy corresponding to the patch-based classification method may result in an overlap between patches in the training set and the test set. During classification of a hyperspectral image, division of the training set and the test set greatly affects accuracy of a result.

Further, after determining through feasibility analysis in S3.1, a dataset division strategy is required to ensure that there is no information leakage between the training set and the test set. The division strategy for a dataset without leakage information provided in this embodiment specifically includes:
(1) First determine two important parameters, namely, a ratio of pixels participating in training to all pixels in an original image, and a quantity T of pixels with annotations in each training block. It may be learned that a quantity of training blocks (Blocks) in each category is as follows:

$${N}_{i} = \frac{{n}_{i} \times λ}{T} ,$$

where
   i represents a category of pixels, Nᵢ represents the quantity of training blocks in a corresponding category (Nᵢ≥1), and nᵢ represents a total of pixels in each category in the original image.
(2) Divide the original image into a to-be-classified training image based on a ratio λ of a pixel participating in training, where a remaining portion is an image to be validated and tested, and there is no overlap between the two images.
(3) Based on the quantity T of pixels with annotations in each training block, select an image having a portion of pixels with annotations from the to-be-classified training image, and define the image having a portion of pixels with annotations as the training image. Similarly, the image to be validated and tested is divided into a validation image and a test image based on a proposed ratio of a validation sample/test sample.
(4) Segment the training image, the leakage image, the validation image, and the test image obtained in step 3 into a block with a size of W×H×B, where W and H represent a width and height of the block, and B represents a quantity of spectral bands. All training blocks and test blocks are obtained after a block that does not have the pixels with annotations is discarded.
(5) Obtain more training patches and test patches from a limited quantity of blocks through a sliding window strategy.

S4: As an improvement, separately extract the spectral feature and the spatial feature from the hyperspectral data in the original image through a 3D-CNN, a densely connected network, a multi-scale extraction module, and a self-attention mechanism in a double-branch multi-scale dual-attention mechanism network (DBMSDA), and then fuse the spectral feature and the spatial feature for classification.

Feature extraction is performed on the training set. The spectral feature and the spatial feature are separately extracted through a double-branch structure. The double-branch structure includes a spectral branch and a spatial branch.

As an improvement, the MSeRA module is designed in the spectral branch, and used as a densely connected network. In combination with the self-attention mechanism, the spectral information can be extracted fully. In combination with a spectral-dimensional multi-scale extraction module and a residual connection module, the MSeRA module is used to extract spectral features at different scales. In the spatial branch, the spatial information is extracted through convolutional dense connection and in combination with the self-attention mechanism. Finally, the spectral feature and the spatial feature are fused for classification.

According to the present disclosure, the research area is divided and the corresponding label is formulated based on the hyperspectral remote sensing image of the China-Brazil earth resource satellite No. 1 satellite. Simply, the hyperspectral remote sensing dataset is prepared. In addition, division performed through the division strategy for a dataset without leakage information ensures that no information between the training set and the test set leaks. Finally, the spectral feature and the spatial feature of the hyperspectral data are extracted based on a deep learning algorithm, and are fused to implement identification and classification of surface lithology. In comparison to a simple convolutional network, the double-branch multi-scale dual-attention mechanism network (DBMSDA) has better effect.

Each embodiment in the description is described in a progressive mode, each embodiment focuses on differences from other embodiments, and references can be made to each other for the same and similar parts between embodiments.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

What is claimed is:

1. An object-oriented method for identifying and classifying surface lithology in a hyperspectral remote sensing image, comprising:
determining a hyperspectral remote sensing image in a research area and a lithology type label corresponding to each hyperspectral remote sensing image, and preparing a hyperspectral remote sensing dataset;
dividing pixels of the hyperspectral remote sensing image in the hyperspectral remote sensing dataset into a training set and a test set through a division strategy for a dataset without leakage information, wherein the division strategy for a dataset without leakage information ensures that there is no overlap between training data in the training set and test data in the test set; and
based on a deep learning method, extracting and fusing, through a double-branch multi-scale dual-attention mechanism network, a spectral feature and a spatial feature of a hyperspectral remote sensing image to be tested, to generate a fused feature, wherein the double-branch multi-scale dual-attention mechanism network is constructed and trained through the training set and the test set; the double-branch multi-scale dual-attention mechanism network comprises a spectral branch, a spatial branch, and a classification head; the spectral branch comprises a multi-scale spectral residual attention (MSeRA) densely connected module and a spectral attention mechanism module, and the spectral branch is used to extract a diagnostic spectral feature in the spectral feature; the spatial branch comprises a spatial densely connected module and a spatial attention mechanism module, and the spatial branch is used to extract a diagnostic spatial feature in the spatial feature; the classification head is used to fuse the diagnostic spectral feature extracted by the spectral branch and the diagnostic spatial feature extracted by the spatial branch, to generate the fused feature; and the fused feature is used to represent a surface lithology type of the hyperspectral remote sensing image to be tested.

2. The object-oriented method for identifying and classifying surface lithology in a hyperspectral remote sensing image according to claim 1, wherein the determining a hyperspectral remote sensing image in a research area and a lithology type label corresponding to each hyperspectral remote sensing image, and preparing a hyperspectral remote sensing dataset specifically comprises:
taking an area in which a bedrock outcrop in the hyperspectral remote sensing image is higher than a preset outcrop area and that is not covered by vegetation as the hyperspectral remote sensing image in the research area;
automatically performing, based on stratigraphic boundary data, label classification on pixels representing each category of lithology in the hyperspectral remote sensing image in the research area, and determining a lithology label map; and
preparing the hyperspectral remote sensing dataset based on the lithology label map and the hyperspectral remote sensing image.

3. The object-oriented method for identifying and classifying surface lithology in a hyperspectral remote sensing image according to claim 2, wherein the dividing pixels of the hyperspectral remote sensing image in the hyperspectral remote sensing dataset into a training set and a test set through a division strategy for a dataset without leakage information specifically comprises:
determining a training parameter, a test parameter, and a validation parameter, wherein the training parameter comprises a ratio of a pixel participating in training to all pixels in an original image and a quantity of pixels with annotations in each training block; the original image is the hyperspectral remote sensing image in the research area; the test parameter comprises a ratio of a pixel participating in testing to all the pixels in the original image, and a quantity of pixels with annotations in each test block; and the validation parameter comprises a ratio of pixels participating in validation to all the pixels in the original image, and a quantity of pixels with annotations in each validation block;
dividing the original image into a to-be-classified training image based on the ratio of a pixel participating in training to all pixels in an original image;
based on the quantity of pixels with annotations in each training block, randomly taking an image having the pixels with annotations from the to-be-classified training image as a training image, constructing the training set, and taking remaining images having pixels with annotations in the to-be-classified training image as a leakage image;
determining a test image based on the test parameter, and constructing the test set; and
determining a validation image based on the validation parameter, and constructing a validation set.

4. The object-oriented method for identifying and classifying surface lithology in a hyperspectral remote sensing image according to claim 3, wherein after the determining a validation image based on the validation parameter, and constructing a validation set, the method further comprises:
determining all training blocks and test blocks based on the training image, the leakage image, the test image, and the validation image; and
obtaining a training patch and a test patch from the training block and the test block through a sliding window strategy.

5. The object-oriented method for identifying and classifying surface lithology in a hyperspectral remote sensing image according to claim 3, wherein after the determining a training parameter, a test parameter, and a validation parameter, the method further comprises:
determining a quantity of training blocks in each category through a formula Nᵢ=nᵢ×λ/T, wherein Nᵢ represents a quantity of training blocks corresponding to an iₜₕ category; and nᵢ represents a total quantity of pixels in the i^{th} category in an original image; λ represents a ratio of a pixel participating in training to all pixels in the original image; and T represents a quantity of pixels with annotations in each training block.

6. The object-oriented method for identifying and classifying surface lithology in a hyperspectral remote sensing image according to claim 1, wherein the MSeRA densely connected module comprises a spectral-dimensional multi-scale extraction module and a residual connection module; and the MSeRA densely connected module is used to extract spectral features at different scales.

7. The object-oriented method for identifying and classifying surface lithology in a hyperspectral remote sensing image according to claim 1, wherein before the determining a hyperspectral remote sensing image in a research area and a lithology type label corresponding to each hyperspectral remote sensing image, and preparing a hyperspectral remote sensing dataset, the method further comprises:
performing pre-processing on the hyperspectral remote sensing image, wherein the pre-processing comprises a radiometric correction, an atmospheric correction, and a geometric correction.
